(19) United States
(12) Patent Application Publication
(10) Pub. No.: US 2025/0059442 A1
(43) Pub. Date: Feb. 20, 2025

(54) GLUCAMIDE-CONTAINING COMPOUNDS FOR CORROSION INHIBITION

(71) Applicant: ChampionX LLC, Sugar Land, TX (US)

(72) Inventors: Jeremy MOLONEY, Katy, TX (US); Jing WU, Missouri City, TX (US)

(73) Assignee: ChampionX LLC, Sugar Land, TX (US)

(21) Appl. No.: 18/795,099

(22) Filed: Aug. 5, 2024

Related U.S. Application Data
(60) Provisional application No. 63/519,414, filed on Aug. 14, 2023.

(51) Int. Cl. C09K 15/22

(52) U.S. Cl. CPC C09K 15/22

(57) ABSTRACT

The present disclosure generally relates to corrosion inhibitor compositions and methods of using the compositions to inhibit corrosion. The corrosion inhibitor compositions include glucamide-containing compounds. The compositions can effectively inhibit corrosion of various metallic surfaces. The metallic surfaces may be found in a pipeline, a downhole tubular, a casing, a tank, a separator, a processing unit, and/or a filter, for example. The compositions may also include additional components, such as solvents, biocides, and scavengers.

### TECHNICAL FIELD

The present disclosure generally relates to corrosion inhibitor compositions and methods of using the compositions to inhibit corrosion. More particularly, the present disclosure relates to corrosion inhibitor compositions including glucamide-containing compounds and methods of using the compositions to inhibit corrosion of a metal surface.

### BACKGROUND

Corrosion inhibitors are often added into upstream oil and gas production fluids to protect carbon steel pipelines and infrastructure from corrosion. Quaternary ammonium compounds, such as dimethyl benzyl ammonium chloride, are commonly used as corrosion inhibitors for the oil and gas industry. Some limitations of standard quaternary ammonium compounds involve reduced performance at higher temperatures and a higher hazard rating including environmental, physical, health, and corrosivity hazards.

There are continued research efforts across the industry to increase the performance and decrease dose rates of corrosion inhibitors through the use of safer chemicals with improved hazard ratings and environmental profiles. Development of new corrosion inhibitors will not only increase sustainability of operations but also reduce costs through less chemical usage, which decreases chemical handling and the associated health and safety risks. To this end, this disclosure involves introducing glucamide-containing compositions for oilfield corrosion inhibition.

### BRIEF SUMMARY

The present disclosure provides methods and compositions for inhibiting corrosion. In some embodiments, the present disclosure provides a method of inhibiting corrosion of a metal surface in contact with a medium. The method comprises adding an effective amount of a composition to the medium, wherein the composition comprises a glucamide-containing compound having a structure of Formula I, Formula II, an enantiomer thereof, and/or a diastereomer thereof,

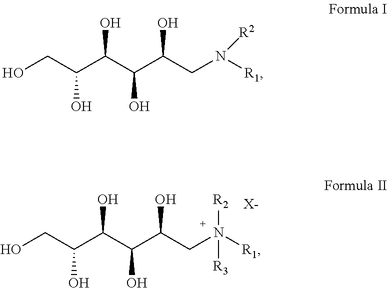

wherein R₁ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;

wherein R₂ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;

wherein R₃ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide; and

wherein X is selected from chloride, bromide, iodide, sulphate, acetate, phosphate, or nitrate.

The present disclosure also provides metal surfaces coated or partially coated with the presently disclosed compositions, compounds, and/or components. In some embodiments, the disclosure provides a metal surface comprising a glucamide-containing compound having a structure of Formula I, Formula II, an enantiomer thereof, and/or a diastereomer thereof,

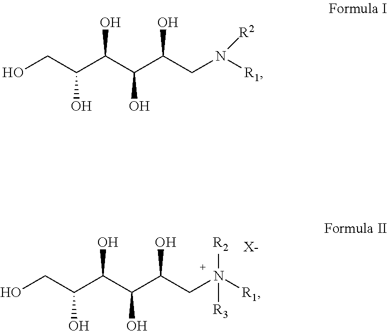

wherein R₁ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;

wherein R₂ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;

wherein R₃ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide; and
wherein X is selected from chloride, bromide, iodide, sulphate, acetate, phosphate, or nitrate.

The foregoing has outlined rather broadly the features and technical advantages of the present disclosure in order that the detailed description that follows may be better understood. Additional features and advantages of the disclosure will be described hereinafter that form the subject of the claims of this application.

### DETAILED DESCRIPTION

Various elements and embodiments of the present disclosure are described below. The relationship and functioning of the various elements and embodiments may be better understood by reference to the following detailed description. However, embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo(fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions and methods for inhibiting corrosion of metallic surfaces. The corrosion inhibitor compositions include glucamide-containing compounds and may include additional components as further described below. Glucamides are mild sugar surfactants and have improved safety and environmental profiles compared with, quaternary ammonium compounds, such as dimethyl benzyl ammonium chloride. The presently disclosed compositions comprising glucamide-containing compounds demonstrated significantly improved performance compared with quaternary ammonium compounds, such as dimethyl benzyl ammonium chloride.

Illustrative, non-limiting examples of glucamide-containing compounds include compounds having the structure of Formula I, Formula II, one or more enantiomers thereof, and/or one or more diastereomers thereof:

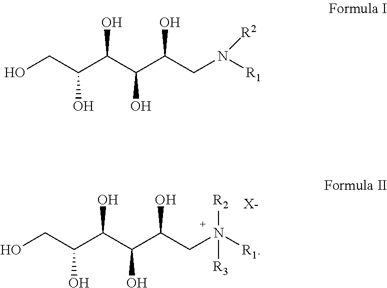

R₁ may be selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom (such as, but not limited to, oxygen, sulfur, nitrogen, and phosphorus), a cyclic group, a non-cyclic group, an aromatic group, a non-aromatic group, a carbonyl group, ethylene oxide, propylene oxide, or butylene oxide. When R₁ is ethoxylated, propoxylated, or butoxylated, the moles of EO, PO, and/or BO may range from about 1 to about 50.

R₂ may be selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom (such as, but not limited to, oxygen, sulfur, nitrogen, and phosphorus), a cyclic group, a non-cyclic group, an aromatic group, a non-aromatic group, a carbonyl group, ethylene oxide, propylene oxide, or butylene oxide. When R₂ is ethoxylated, propoxylated, or butoxylated, the moles of EO, PO, and/or BO may range from about 1 to about 50.

R₃ may be selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom (such as, but not limited to, oxygen, sulfur, nitrogen, and phosphorus), a cyclic group, a non-cyclic group, an aromatic group, a non-aromatic group, a carbonyl group, ethylene oxide, propylene oxide, or butylene oxide. When R₃ is ethoxylated, propoxylated, or butoxylated, the moles of EO, PO, and/or BO may range from about 1 to about 50.

Any R group disclosed herein (e.g., R₁, R₂, or R₃) may be a C₁ to C₅₀ alkyl group, a C₁ to C₄₀ alkyl group, a C₁ to C₃₀ alkyl group, a C₁ to C₂₀ alkyl group, a C₁ to C₁₀ alkyl group, a C₁ to C₅ alkyl group, a C to C₅₀ alkyl group, a C₁₀ to C₅₀ alkyl group, a C₁₅ to C₅₀ alkyl group, a C₂₀ to C₅₀ alkyl group, a C₂₅ to C₅₀ alkyl group, a C₃₀ to C₅₀ alkyl group, a C₃₀ to C₅₀ alkyl group, a C₃₅ to C₅₀ alkyl group, or a C₄₀ to C₅₀ alkyl group. In some aspects, the R group may be a C₁ to C₄₀ alkenyl group, a C₁ to C₃₀ alkenyl group, a C₁ to C₂₀ alkenyl group, a C₁ to C₁₀ alkenyl group, a C₁ to C₅ alkenyl group, a C₅ to C₅₀ alkenyl group, a C₁₀ to C₅₀ alkenyl group, a C₁₅ to C₅₀ alkenyl group, a C₂₀ to C₅₀ alkenyl group, a C₂₅ to C₅₀ alkenyl group, a C₃₀ to C₅₀ alkenyl group, a C₃₀ to C₅₀ alkenyl group, a C₃₅ to C₅₀ alkenyl group, or a C₄₀ to C₅₀ alkenyl group.

As illustrative, non-limiting examples, any R group disclosed herein (e.g., R₁, R₂, or R₃) may be a C₅ to C₂₀ alkyl group, a C₇ to C₁₇ alkyl group, a C₇ alkyl group, a C₉ alkyl group, a C₁₁ alkyl group, a C₁₃ alkyl group, a C₁₅ alkyl group, a C₁₇ alkyl group, a C₅ to C₂₀ alkenyl group, a C₇ to C₁₇ alkenyl group, a C₇ alkenyl group, a C₉ alkenyl group, a C₁₁ alkenyl group, a C₁₃ alkenyl group, a C₁₅ alkenyl group, or a C₁₇ alkenyl group.

A composition of the present disclosure may include more than one compound falling under the scope of Formula I wherein each compound is structurally distinct. A composition of the present disclosure may include more than one compound falling under the scope of Formula II wherein each compound is structurally distinct. Further, a composition of the present disclosure may include more than one compound falling under the scope of Formula I and Formula II wherein each compound is structurally distinct.

The X group of Formula II may be selected from chloride, bromide, iodide, sulphate, acetate, phosphate, or nitrate.

Compositions disclosed herein may include the glucamide-containing compound in a non-salt form (e.g., Formula I), but they may additionally or alternatively include a glucamide-containing compound in a salt form (e.g., Formula II). Additionally, compositions disclosed herein may include an enantiomer of the structure shown in Formula I and/or a diastereomer of the structure shown in Formula I. Further, the compositions disclosed herein may include an enantiomer of the structure shown in Formula II and/or a diastereomer of the structure shown in Formula II.

Additional non-limiting examples may be selected from cocoyl methyl glucamide (CAS No. 1591783-13-9), lauroyl methyl glucamide (CAS No. 87246-72-8), myristoyl methyl glucamide (CAS No. 87157-58-2), sunfloweroyl methyl glucamide (CAS No. 1591782-99-8), and any combination thereof.

In some embodiments, the glucamide-containing compound comprises the following structure, a salt thereof, an enantiomer thereof, and/or a diastereomer thereof:

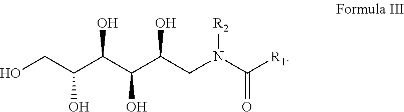

The R₁ and R₂ groups are as defined above.

In some embodiments, the glucamide-containing compound comprises the following structure, an enantiomer thereof, and/or a diastereomer thereof:

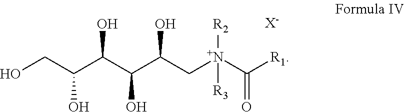

The X, R₁, R₂, and R₃ groups are as defined above.

In some embodiments, the glucamide-containing compound comprises the following structure, a salt thereof, an enantiomer thereof, and/or a diastereomer thereof:

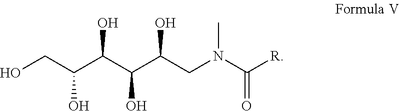

The R group may be selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom (such as, but not limited to, oxygen, sulfur, nitrogen, and phosphorus), a cyclic group, a non-cyclic group, an aromatic group, a non-aromatic group, ethylene oxide, propylene oxide, or butylene oxide. When R is ethoxylated, propoxylated, or butoxylated, the moles of EO, PO, and/or BO may range from about 1 to about 50.

While the compositions disclosed herein include a glucamide-containing compound, they may also comprise various optional components. For example, the compositions may comprise 2-mercaptoethanol, an imidazoline compound, a pyridinium compound, a quaternary ammonium compound, a phosphate ester, an amine, an amide, a carboxylic acid, a thiol, a fouling control agent, an additional corrosion inhibitor, a biocide, a preservative, an acid, an anti-emulsifier, an iron chelating agent, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, and any combination thereof. The compositions disclosed herein may also exclude any of the foregoing components.

Further, while any of the foregoing optional components may be part of the composition comprising the glucamide-based compound, the components may additionally or alternatively be added to the aqueous medium separate from the composition comprising the glucamide-based compound. For example, any component mentioned above (or any combination of the components mentioned above) may be added to the aqueous medium before the composition, with the composition, and/or after the composition.

Illustrative, non-limiting examples of imidazoline compounds include, but are not limited to,
(A) an imidazoline of Formula (I):

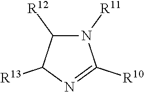

wherein R¹⁰ is a C₁-C₂₀ alkyl group or a C₁-C₂₀ alkoxyalkyl group;
R¹² and R¹³ are independently selected from hydrogen or a C₁-C₆ alkyl group; and
R¹¹ is hydrogen, a C₁-C₆ alkyl group, a C₁-C₆ hydroxyalkyl group, an aminoalkyl group, an aminoaryl group, an aminoarylalkyl group, an aminoalkylaryl group, or a C₁-C₆ arylalkyl group;
(B) an imidazolinium salt of Formula (II):

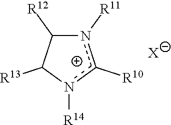

wherein R¹⁰ is a C₁-C₂₀ alkyl group or a C₁-C₂₀ alkoxyalkyl group; R¹² and R¹³ are independently selected from hydrogen or a C₁-C₆ alkyl group; R¹¹ and R¹⁴ are independently selected from hydrogen, a C₁-C₆ alkyl group, a C₁-C₆ hydroxyalkyl group, or a C₁-C₆ arylalkyl group; and X⁻ is a halide, a carbonate, a sulfonate, a phosphate, or an anion of an organic carboxylic acid;
(C) a bis-quaternized imidazoline compound of Formula (III):

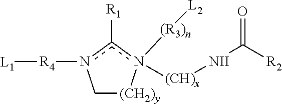

wherein R₁, R₂, R₃ and R₄, are each independently selected from a C₁-C₃₀ alkyl group, a C₁-C₃₀ alkenyl group, a C₁-C₃₀ cycloalkyl group, or a C₁-C₃₀ cycloalkenyl group; optionally wherein R₁, R₂, R₃ and/or R₄, is partially or fully oxygenized, sulfurized, and/or phosphorylized; L₁ and L₂ are each independently selected from absent, H, —COOH, —SO₃H, —PO₃H₂, —COOR₅, —CONH₂, —CONHR₅, or —CON(R₅)₂; R₅ is selected from a C₁-C₁₀ alkyl group, a C₄-C₁₀ aryl group, a C₅-C₁₀ alkylaryl group, a C₅-C₁₀ alkylheteroaryl group, a C₃-C₁₀ cycloalkyl group, or a C₄-C₁₀ heteroaryl group;
n is 0 or 1, and when n is 0, L₂ is absent or H; x is from 1 to about 10; and y is from 1 to about 5.

The imidazoline may be, for example, an imidazoline of Formula (I) or the imidazolinium salt of Formula (II), wherein R¹⁰ is an alkyl mixture of tall oil fatty acid (TOFA), R¹¹ is benzyl, R¹² and R¹³ are each hydrogen, R¹⁴ is hydroxyethyl, and X⁻ is chloride. Further the imidazoline compound may be, for example, the bis-quaternized imidazoline compound of Formula (III), R₁ and R₂ are derived from a mixture of tall oil fatty acids and comprise a mixture of C₁₇H₃₃ and C₁₇H₃₁, x is 2, y is 1, R₃ and R₄ are —C₂H₂—, and L₁ and L₂ are —CO₂H, —SO₃H, or —PO₃H₂. The imidazoline may also be the bis-quaternized imidazoline compound of Formula (III), R₁ and R₂ are independently a C₁₆-C₁₈ alkyl group; R₄ is —C₂H₂—; x is 2; y is 1; n is 0; L₁ is —COOH, —SO₃H, or —PO₃H₂ and L₂ is absent or H.

Illustrative, non-limiting examples of quaternary ammonium compounds include, but are not limited to, alkyl, hydroxyalkyl, alkylaryl, arylalkyl and/or arylamine quaternary salts.

Suitable alkyl, hydroxyalkyl, alkylaryl arylalkyl or arylamine quaternary salts include those alkylaryl, arylalkyl and arylamine quaternary salts of the formula [N+R^{1a}R^{2a}R^{3a}R^{4a}][X⁻] wherein R^{1a}, R^{2a}, R^{3a}, and R^{4a} contain one to 18 carbon atoms, and X is Cl, Br or I. For the quaternary amine, R^{1a}, R^{2a}, R^{3a}, and R^{4a} can each independently be selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N+R^{1a}R^{2a}R^{3a}R^{4a}][X-] wherein R^{1a}, R^{2a}, R^{3a}, and R^{4a} contain one to 18 carbon atoms, and X is Cl, Br or I.

Suitable quaternary ammonium salts include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds, wherein the alkyl group can contain between about 1 and about 24 carbon atoms, about 10 and about 18 carbon atoms, or about 12 to about 16 carbon atoms, such as, for example, C₁₂₋₁₆ benzyl dimethyl ammonium chloride.

Additional examples include, but are not limited to, trialkyl, dialkyl, dialkoxy alkyl, monoalkoxy, benzyl, and imidazolinium quaternary ammonium compounds, salts thereof, the like, and combinations thereof. The quaternary ammonium salt can be an alkylamine benzyl quaternary ammonium salt, a benzyl triethanolamine quaternary ammonium salt, or a benzyl dimethylaminoethanolamine quaternary ammonium salt.

Further, the quaternary amine can be a benzalkonium salt (or mixture of benzalkonium salts) represented by the formula:

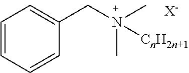

wherein n is 8, 10, 12, 14, 16, or 18; and X is Cl, Br or I.

The optional pyridinium compound is not particularly limited and may be selected from, for example, an alkyl pyridinium quaternary salt, such as those represented by the general formula:

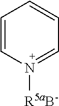

wherein R^{5a} is an alkyl group, an aryl group, or an arylalkyl group, wherein said alkyl groups have from 1 to about 18 carbon atoms and B is Cl, Br or I.

Among these compounds are alkyl pyridinium salts and alkyl pyridinium benzyl quats. Examples include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride. In some aspects, the alkyl is a C₁-C₆ hydrocarbyl group.

The optional fouling control agent may comprise, for example, a quaternary compound.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

The optional acid may comprise, for example, hydrochloric acid, hydrofluoric acid, citric acid, formic acid, acetic acid, or any combination thereof.

Illustrative, non-limiting examples of anti-emulsifiers include, for example, acrylic acid, a polymer comprising acrylic acid and T-butylphenol, such as CAS No. 178603-70-8, an oxyalkylate polymer, an ethylene oxide (EO) polymer, a propylene oxide (PO) polymer, formaldehyde, maleic anhydride, 4-nonylphenol, propenoic acid, a polymer comprising 2,5-furandione, methyloxirane and/or oxirane, a reaction product of EO-PO and an epoxy resin, such as CAS No. 68036-95-3, an acrylic acid polymer with T-butylphenol, formaldehyde, maleic anhydride, EO, PO, and 4-nonylphenol, such as CAS No. 129828-31-5, a propenoic acid polymer with 2,5-furandione, methyloxirane and oxirane, such as CAS No. 178603-71-9, and a reaction product of EO-PO, 4-nonylphenol, formaldehyde, maleic anhydride, and acrylic acid, such as CAS No. 67905-91-3.

Additional illustrative examples of anti-emulsifier compounds include dodecylbenzylsulfonic acid (DDBSA), the sodium salt of xylenesulfonic acid (NAXSA), an anionic surfactant, a cationic surfactant, a nonionic surfactant, a polyoxyalkylene, a vinyl polymer, a polyamine, a polyamide, a phenol, and a silicone polyether.

The optional hydrogen sulfide scavenger component may comprise, for example, an oxidant, inorganic peroxide, chlorine dioxide, a C₁-C₁₀ aldehyde, formaldehyde, glyoxal, glutaraldehyde, acrolein, methacrolein, a triazine, or any combination thereof.

Illustrative, non-limiting examples of surfactants include non-ionic, cationic, anionic, amphoteric, or zwitterionic surfactants.

Illustrative, non-limiting examples of asphaltene inhibitors include an alkylphenol/formaldehyde resin, a polyisobutylene esters, a polyisobutylene imides, a polyalkyl acrylate, and any combination thereof.

Illustrative, non-limiting examples of paraffin inhibitors include a polyalkyl acrylate, an olefin/maleic anhydride polymer, and any combination thereof.

Illustrative, non-limiting examples of scale inhibitors include a phosphonate, a sulfonate, a phosphate, a phosphate ester, a polymer comprising a phosphonate or phosphonate ester group, a polymeric organic acid, a peroxycarboxylic acid, and any combination thereof. In some aspects, the scale inhibitor may be selected from a compound comprising an amine and/or a quaternary amine, nitrilotriacetic acid (NTA), ethylenediaminetetraacetic acid (EDTA), DETA phosphonate, and any combination thereof. In some aspects, the scale inhibitor is an acid-based scale inhibitor, such as phosphonic acid.

In certain aspects, the scale inhibitor comprises an anionic group. The anionic group may comprise, for example, a carboxylate group or a sulfate group.

In some aspects, the scale inhibitor may include a phosphorous atom, a phosphorous-oxygen double bond, and/or a phosphono group.

In some aspects, the scale inhibitor is selected from the group consisting of hexamethylene diamine tetrakis(methylene phosphonic acid), diethylene triamine tetra(methylene phosphonic acid), diethylene triamine penta(methylene phosphonic acid), polyacrylic acid (PAA), phosphino carboxylic acid (PPCA), diglycol amine phosphonate (DGA phosphonate), 1-hydroxyethylidene 1,1-diphosphonate (HEDP phosphonate), bisaminoethylether phosphonate (BAEE phosphonate), 2-acrylamido-2-methyl-1-propanesulphonic acid (AMPS), and any combination thereof.

In certain aspects, the scale inhibitor is a polymer comprising an anionic monomer. The anionic monomer may be selected from, for example, acrylic acid, methacrylic acid, vinyl sulfonic acid, vinyl phosphonic acid, maleic anhydride, itaconic acid, crotonic acid, maleic acid, fumaric acid, styrene sulfonic acid, and any combination thereof.

The optional gas hydrate inhibitor component may include, for example, a mono-alkyl amide, a dialkyl amide, an alkyl quaternary ammonium salt, and any combination thereof.

The compositions disclosed herein may comprise from about 1 wt. % to about 100 wt. % of the glucamide-containing compound. For example, a composition disclosed herein may comprise from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 1 wt. % to about 5 wt. %, about 5 wt. % to about 10 wt. %, about 5 wt. % to about 20 wt. %, about 5 wt. % to about 30 wt. %, about 5 wt. % to about 40 wt. %, or about 5 wt. % to about 50 wt. % of the glucamide-containing compound.

The compositions disclosed herein may comprise from about 1 wt. % to about 90 wt. % of the optional component. For example, a composition disclosed herein may comprise from about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 1 wt. % to about 5 wt. %, about 5 wt. % to about 10 wt. %, about 5 wt. % to about 20 wt. %, about 5 wt. % to about 30 wt. %, about 5 wt. % to about 40 wt. %, or about 5 wt. % to about 50 wt. % of the optional component.

The compositions disclosed herein may optionally comprise a solvent. For example, the compositions may comprise from about 1 wt. % to about 95 wt. % of the solvent, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 1 wt. % to about 5 wt. %, about 5 wt. % to about 95 wt. %, about 15 wt. % to about 95 wt. %, about 25 wt. % to about 95 wt. %, about 35 wt. % to about 95 wt. %, about 45 wt. % to about 95 wt. %, about 55 wt. % to about 95 wt. %, about 65 wt. % to about 95 wt. %, about 60 wt. % to about 90 wt. %, about 50 wt. % to about 85 wt. %, about 40 wt. % to about 80 wt. %, or about 35 wt. % to about 75 wt. % of the solvent.

Various solvents may be utilized with the presently disclosed compositions. Illustrative, non-limiting examples of solvents include an alcohol, a hydrocarbon, a ketone, an ether, an aromatic, an amide, a nitrile, a sulfoxide, an ester, a glycol ether, water, and combinations thereof. For example, the solvent can be water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

Representative polar solvents suitable for formulation with the composition include water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), a glycol and a glycol derivative (e.g., ethylene glycol, 1,2-propylene glycol, 1,3-propylene glycol, ethylene glycol monobutyl ether, etc.), a ketone (such as cyclohexanone, diisobutylketone), N-methylpyrrolidinone (NMP), N,N-dimethylformamide, and the like.

Representative non-polar solvents suitable for formulation with the composition include an aliphatic, such as pentane, hexane, cyclohexane, methylcyclohexane, heptane, decane, dodecane, diesel, and the like; and an aromatic, such as toluene, xylene, heavy aromatic naphtha, a fatty acid derivative (e.g., an acid, an ester, an amide), and the like.

In some embodiments, the solvent is selected from the group consisting of water, a C₁-C₆ alkanol, a C₁-C₆ alkoxyalkanol, an alcohol, a glycol ether, a hydrocarbon, a ketone, an ether, an aromatic, an alkylene glycol, an amide, a nitrile, a sulfoxide, an ester, and any combination thereof.

The pH of a composition disclosed herein is not particularly limited and may be selected based upon, for example, the compounds and/or components present in the composition, the intended use of the composition, etc. In some embodiments, the composition has a pH from about 1 to about 11, such as from about 1 to about 10, from about 1 to about 9, from about 1 to about 8, from, from about 1 to about 7.5, from about 1 to about 7, from about 2 to about 8, from about 3 to about 8, from about 4 to about 8, from about 5 to about 8, from about 6 to about 8, or from about 7 to about 8.

The present disclosure also provides methods of inhibiting corrosion of a metal surface in contact with an aqueous medium. The methods include adding any of the compounds, components, and/or compositions disclosed herein to the aqueous medium. In some embodiments, the compounds, components, and/or compositions disclosed herein may be added directly to the metal surface, optionally in the absence of the aqueous medium. For example, the compounds, components, and/or compositions disclosed herein may independently be added to the aqueous medium, the metal surface (optionally in the absence of the aqueous medium), and any combination thereof.

In some embodiments, the method may involve adding an effective amount of a composition to the medium, wherein the effective amount is from about 1 ppm to about 50,000 ppm.

In some aspects, the method may involve adding an effective amount from about 1 ppm to about 45,000 ppm, from about 1 ppm to about 40,000 ppm, from about 1 ppm to about 35,000 ppm, from about 1 ppm to about 30,000 ppm, from about 1 ppm to about 25,000 ppm, from about 1 ppm to about 20,000 ppm, from about 1 ppm to about 15,000 ppm, from about 1 ppm to about 10,000 ppm, from about 1 ppm to about 5,000 ppm, from about 1 ppm to about 2,000 ppm, from about 1 ppm to about 1,000 ppm, from about 1 ppm to about 500 ppm, from about 100 ppm to about 250 ppm, from about 1 ppm to about 100 ppm, from about 5 ppm to about 5,000 ppm, from about 5 ppm to about 1,000 ppm, from about 5 ppm to about 500 ppm, from about 5 ppm to about 50 ppm, or from about 1 ppm to about 30 ppm.

In some embodiments, the aqueous medium may comprise a corrodent selected from the group consisting of hydrogen sulfide, carbon dioxide, oxygen, sodium chloride, calcium chloride, sulfur dioxide, and any combination thereof.

The methods disclosed herein are useful for inhibiting corrosion of metal surfaces in contact with any type of corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

The methods disclosed herein are useful for inhibiting corrosion of metal surfaces in contact with any types of mediums. Illustrative, non-limiting examples of mediums include produced water, fresh water, recycled water, condensed water, desalinated water, waste water, salt water, surface water, or any mixture thereof.

In some aspects, the medium is an aqueous medium, such as produced water, seawater, municipal water, “gray” water, brackish water, fresh water, recycled water, salt water, surface water, connate, groundwater, wastewater, or any combination of the foregoing. The aqueous medium may be a continuously flowing medium, such as produced water flowing from a subterranean reservoir and into or through a pipe or tank. The aqueous medium may also be, for example, wastewater isolated from a continuous manufacturing process flowing into a wastewater treatment apparatus. In other embodiments, the aqueous medium is a batch, or plug, substantially disposed in a batchwise or static state within a metal containment.

In some embodiments, the metal surface may comprise carbon steel. In some embodiments, the metal surface may exclude carbon steel.

The metal of the surface is not particularly limited and may include, as illustrative examples, stainless steel, carbon steel, iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen.

In some embodiments, a pipeline, a downhole tubular, a casing, a tank, a separator, a processing unit, and/or a filter may comprise the metal surface.

In some aspects, a pipe or a tank (e.g., railroad tank car or a tank truck/tanker) comprises the metal surface.

The methods disclosed herein can be used in any industry where it is desirable to inhibit corrosion. For example, a composition can be applied to a gas or liquid produced or used in the production, transportation, storage, and/or separation of crude oil or natural gas. A fluid to which the composition can be introduced may be an aqueous medium. The aqueous medium can comprise water, gas, and optionally liquid hydrocarbon. The liquid hydrocarbon may be any type of liquid hydrocarbon including, but not limited to, crude oil, heavy oil, processed residual oil, bitminous oil, coker oils, coker gas oils, fluid catalytic cracker feeds, gas oil, naphtha, fluid catalytic cracking slurry, diesel fuel, fuel oil, jet fuel, gasoline, and kerosene. The fluid or gas may also be a refined hydrocarbon product.

The fluid or gas in which the compositions of the disclosure are introduced can be contained in and/or exposed to many different types of apparatuses. For example, the fluid or gas can be contained in an apparatus that transports fluid or gas from one point to another, such as an oil and/or gas pipeline. The apparatus can be part of an oil and/or gas refinery, such as a pipeline, a separation vessel, a dehydration unit, or a gas line. The fluid can also be contained in and/or exposed to an apparatus used in oil extraction and/or production, such as a wellhead.

In some aspects, the medium and/or metal surface to be treated with the presently disclosed composition may be located in a cooling water system, a boiler water system, a petroleum well, a downhole formation, a geothermal well, a mineral washing process, a flotation and benefaction process, a papermaking process, a gas scrubber, an air washer, a continuous casting processes, an air conditioning and refrigeration process, a water reclamation process, a water purification process, a membrane filtration process, a clarifier, a municipal sewage treatment process, a municipal water treatment process, or a potable water system.

The components, compounds, and/or compositions disclosed herein may be added to the medium and/or metallic surface continuously, automatically, intermittently, and/or manually, for example.

The foregoing may be better understood by reference to the following examples, which are intended for illustrative purposes and are not intended to limit the scope of the disclosure or its application in any way.

### Examples

### Corrosion Bubble Cell Tests

Tests were performed using the following conditions to evaluate the corrosion inhibition performance of the various corrosion inhibitor blends on a carbon steel electrode (C1018 grade). The corrosion rate was assessed electrochemically using linear polarization resistance (LPR) methodology.

The carbon steel electrode was held at 80° C. in CO₂ saturated fluids with 3% NaCl brine (80%) and LVT-200 hydrocarbon (a hydrotreated light distillate) (20%) with continuous CO₂ sparge at atmospheric pressure. A pre-corrosion time (i.e. with no corrosion inhibitor) was carried out for about 3-4 h before about 20 ppm of a composition comprising a glucamide-containing compound (about 10 wt. %) with about 1 wt. % 2-mercaptoethanol in a methanol solvent was added. This equates to about 2 ppm of the active glucamide-containing compound with about 0.2 ppm 2-mercaptoethanol being introduced into the test cell.

Comparison with a commonly used quaternary ammonium chloride was made. The corrosion inhibitors were assessed at the same active concentration along with the same concentration of 2-mercaptoethanol. A low concentration was purposefully used in order to differentiate between the corrosion inhibitors. The inhibited corrosion rate at about 15 h after corrosion inhibitor chemical injection was noted and a percentage inhibition determined by comparing with the corrosion rate of a carbon steel electrode under otherwise the same conditions in the absence of chemical corrosion inhibitor after the same time of exposure to the corrosive environment. The results are shown in Table 1.

TABLE 1

| | 2-Mercaptoethanol | Active CI | | Corrosion Rate | |
|---|---|---|---|---|---|
| | Active Injected in | Injected in | Dosage | After 15 h of CI | % |
| Composition | Test (ppm) | Test (ppm) | (ppm) | Injection (mpy) | Protection |
| Blank | N/A | N/A | N/A | 502 | N/A |
| Dimethyl benzyl | 0.2 | 2 | 20 | 353 | 30 |
| ammonium | | | | | |
| chloride | | | | | |
| Cocoyl methyl | 0.2 | 2 | 20 | 172 | 66 |
| glucamide | | | | | |
| CAS No. | | | | | |
| 1591783-13-9 | | | | | |
| Lauroyl/myristoyl | 0.2 | 2 | 20 | 175 | 65 |
| methyl glucamide | | | | | |
| CAS No. | | | | | |
| 87246-72-8 and | | | | | |
| 87157-58-2 | | | | | |
| Sunfloweroyl | 0.2 | 2 | 20 | 169 | 66 |
| methyl glucamide | | | | | |
| CAS No. | | | | | |
| 1591782-99-8 | | | | | |

In Table 1, “CI” represents corrosion inhibitor.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a component” is intended to include “at least one component” or “one or more components.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface in contact with a medium, comprising:
adding an effective amount of a composition to the medium, wherein the composition comprises a glucamide-containing compound having a structure of Formula I, Formula II, an enantiomer thereof, and/or a diastereomer thereof, 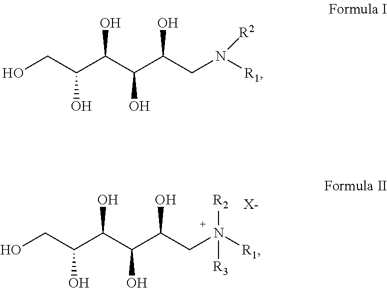
wherein R₁ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;
wherein R₂ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;
wherein R₃ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide; and
wherein X is selected from chloride, bromide, iodide, sulphate, acetate, phosphate, or nitrate.

2. The method of claim 1, wherein the glucamide-containing compound is selected from the group consisting of cocoyl methyl glucamide, lauroyl methyl glucamide, myristoyl methyl glucamide, sunfloweroyl methyl glucamide, and any combination thereof.

3. The method of claim 1, further comprising adding to the medium a compound selected from the group consisting of 2-mercaptoethanol, an imidazoline compound, a pyridinium compound, a quaternary ammonium compound, a phosphate ester, an amine, an amide, a carboxylic acid, a thiol, and any combination thereof.

4. The method of claim 1, wherein the effective amount is from about 1 ppm to about 50,000 ppm.

5. The method of claim 1, wherein the medium comprises produced water, fresh water, cooling water, geothermal water, recycled water, condensed water, desalinated water, waste water, salt water, surface water, or any mixture thereof.

6. The method of claim 1, further comprising adding to the medium a component selected from the group consisting of a fouling control agent, an additional corrosion inhibitor, a biocide, a preservative, an acid, an anti-emulsifier, an iron chelating agent, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, and any combination thereof.

7. The method of claim 6, wherein the component is added before, after, and/or with the composition.

8. The method of claim 1, wherein the composition comprises a solvent.

9. The method of claim 8, wherein the solvent is selected from the group consisting of water, a C₁-C₆ alkanol, a C₁-C₆ alkoxyalkanol, an alcohol, a glycol ether, a hydrocarbon, a ketone, an ether, an aromatic, an alkylene glycol, an amide, a nitrile, a sulfoxide, an ester, and any combination thereof.

10. The method of claim 1, wherein the composition comprises from about 0.1 wt. % to about 100 wt. % of the glucamide-containing compound.

11. The method of claim 1, wherein the medium comprises from about 1 ppm to about 1,000 ppm of the glucamide-containing compound.

12. The method of claim 1, wherein a pipeline, a downhole tubular, a casing, a tank, a separator, a processing unit, and/or a filter comprises the metal surface.

13. The method of claim 3, wherein the composition consists of or consists essentially of the glucamide-containing compound, the compound, and optionally a solvent.

14. The method of claim 6, wherein the composition consists of or consists essentially of the glucamide-containing compound, the component, and optionally the compound and/or a solvent.

15. The method of claim 1, wherein the method excludes adding to the medium a sulfur-containing compound.

16. The method of claim 15, wherein the sulfur-containing compound is a thiol, a thioether, a thiosulfate, thioglycolic acid, a thiourea, or any combination thereof.

17. The method of claim 1, wherein the glucamide-containing compound and/or the composition is not encapsulated.

18. A metal surface, comprising:
a glucamide-containing compound having a structure of Formula I, Formula II, an enantiomer thereof, and/or a diastereomer thereof, 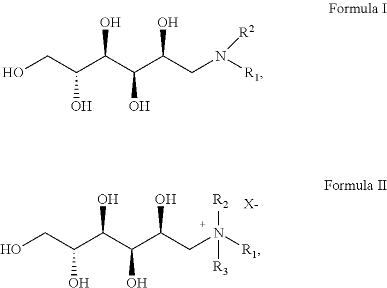
wherein R₁ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;
wherein R₂ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide;
wherein R₃ is selected from a saturated or unsaturated C₁ to C₅₀ alkyl group, a saturated or unsaturated C₁ to C₅₀ alkenyl group, a hydroxyl group, hydrogen, an amido group, a fatty amido group, a quaternary amine, an acid, a fatty alcohol, an ester, a heteroatom, a cyclic group, a non-cyclic group, an aromatic group, a non-aromatic group, a carbonyl group, ethylene oxide, propylene oxide, or butylene oxide; and
wherein X is selected from chloride, bromide, iodide, sulphate, acetate, phosphate, or nitrate.

19. The metal surface of claim 18, wherein the metal surface comprises stainless steel, carbon steel, iron, aluminum, zinc, chromium, manganese, nickel, tungsten, molybdenum, titanium, vanadium, cobalt, niobium, copper, boron, phosphorus, sulfur, silicon, oxygen, nitrogen, or any combination thereof.
